(19) United States
(12) Patent Application Publication
(10) Pub. No.: US 2018/0044614 A1
(43) Pub. Date: Feb. 15, 2018

(54) PERFUMED FILLED CLEANING FLUIDS

(71) Applicant: Conopco, Inc., d/b/a UNILEVER, Englewood Cliffs, NJ (US)

(72) Inventors: Clare Anne JONES, Liverpool (GB); Paul Simon STEVENSON, Liverpool (GB)

(73) Assignee: Conopco, Inc., d/b/a UNILEVER, Englewood Cliffs, NJ (US)

(21) Appl. No.: 15/552,682

(22) PCT Filed: Feb. 25, 2016
(86) PCT No.: PCT/EP2016/054025

§ 371 Date: Aug. 22, 2017

(30) Foreign Application Priority Data
Mar. 2, 2015 (EP) 15157240.1

(51) Int. Cl. C11D 3/37; C11D 3/50; C11D 11/00; C11D 1/83

(52) U.S. Cl. CPC C11D 3/3723; C11D 1/83; C11D 3/50; C11D 11/0094; C11D 1/662

(57) ABSTRACT

A viscous fluid cleaning composition for a cleaning a substrate comprising (a) a surfactant combination comprising (i) at least one surfactant; and (ii) a glycolipid biosurfactant which is present at a level in the range 10-95 wt % of the total surfactant in said surfactant system, and (b) one or more viscosity modifiers; and (c) ethoxylated polyethylene imine (EPEI) and (d) a volatile benefit agent; wherein the composition has a pour viscosity as measured at 21 s-1 of between 250 CPs to 3000 Cps.

This invention relates to perfumed cleaning fluids. The fluids are in particular, but not exclusively, for use in aqueous based treatments such as personal bathing, washing of fabrics and dishes.

Consumers desire certain perfumed cleaning fluids to have high or ‘thick’ pouring viscosities to invoke emotive feelings of richness, luxurious and delight whilst using such products.

An object of the invention is to provide a perfumed viscous cleaning composition for washing of dishes and/or fabrics with improved viscosity profile.

WO 2014/173659 describes a fluid cleaning composition comprising: (a) a surfactant combination comprising (i) a synthetic surfactant; and (ii) a glycolipid biosurfactant which is present at a level in the range 10-95wt % of the total surfactant in said surfactant combination, and (b) a benefit agent suspended in said fluid cleaning composition characterised in that the benefit agent comprises an encapsulate.

According to a first aspect of the present invention there is provided a viscous fluid cleaning composition for a cleaning a substrate comprising:
(a) a surfactant combination comprising:
   (i) at least one surfactant; and
   (ii) a glycolipid biosurfactant which is present at a level in the range 10-95 wt % of the total surfactant in said surfactant system, and
(b) one or more viscosity modifiers; and
(c) ethoxylated polyethylene imine (EPEI)
(d) a volatile benefit agent;
wherein the composition has a pour viscosity as measured at 21 s⁻¹ of between 250 CPs to 3000 Cps.

The surfactant combination may be termed a surfactant system. Said surfactant system may refer to the total surfactant in the composition.

According to a second aspect of the invention there is provided a method for making a viscous fluid cleaning composition for cleaning a substrate with a high pouring viscosity, the composition comprising the steps of:
(a) admixing a surfactant combination by mixing:
   (i) at least one surfactant; and
   (ii) a glycolipid biosurfactant which is present at a level in the range 10-95 wt % of the total surfactant in said surfactant system,
(b) one or more viscosity modifiers
(c) ethoxylated polyethylene imine EPEI and/or
(d) a volatile benefit agent.

With the invention control over pour viscosity and phase stability can be achieved in a perfumed cleaning composition with the particular combination of a glycolipid surfactant as part of the total surfactant mixture and EPEI and a viscosity modifier. The substrate is preferably a fabric surface or a hard surface (such as a work surface or cutlery or crockery). Use of viscosity modifiers is normally limited owing to resultant phase separation/formulation failure occurring upon the addition of perfume when ethoxylated polyethylene imine (EPEI) is present in the formulation. However with rhamnolipid as part of the surfactant system then desired viscosity can be achieved and no phase separation occurs.

Preferably the viscosity is measured at Anton Paar ASC Rheometer at 25° C. Throughout this specification where “%” or “wt. %” is used, it is intended to mean % by weight.

Preferably the viscosity of the composition is in the range 250-1000 Cps for Laundry liquids and 400-4000 Cps for Hand dishwash formulations.

Preferably the pour viscosity of the composition is in the range 300-650 Cps for Laundry Liquid and 800-2500 Cps for Hand dish wash formulations.

Preferably addition of the glycolipid surfactant and the or each viscosity modifier is prior to the addition of any volatile benefit agent.

Preferably the glycolipid comprises a rhamnolipid. The rhamnolipid may comprise a mono-rhamnolipid (R1) and/or and di-rhamnolipid (R2).

The glycolipid may comprise mixtures with R1:R2 ratio in the range: 10:90 wt %-90:10 wt %0%.

A preferred ratio of R1 and R2 is 50:50.

Additionally or alternatively the glycolipid may comprise a sophorolipid or mannosylerythritol lipid (MEL) or any combination thereof.

Preferably the glycolipid is present at 5%-95% of the total surfactant combination, or more preferably between 5-60%.

The surfactant combination preferably comprises a synthetic anionic surfactant. ‘Anionic surfactants’ are defined herein as amphiphilic molecules comprising one or more functional groups that exhibit a net anionic charge when in aqueous solution at the normal wash pH of between 4 and 11.

Preferably the alkali metal salts of organic sulphur reaction products having in their molecular structure an alkyl moiety containing from about 6 to 24 carbon atoms, more greater than 12 carbon atoms and preferably also a moiety selected from the group consisting of sulphonic and sulphuric acid ester moieties. Additionally or alternatively, the anionic surfactant preferably has low levels of ethoxylation, preferably comprising 1-12 ethylene oxide units per molecule, more preferably 1-3 and even more preferably 1. The units of ethylene oxide may be an average.

Providing the formulation scientist with the freedom to use longer carbon chain lengths and/or lower levels of ethoxylation is greatly beneficial, not least on cost grounds.

However these factors increase calcium intolerance and so such surfactants are advantageous selections for the present invention.

Preferred anionic surfactants include primary alkyl sulphates (PAS) e.g., sodium lauryl sulphate (SLS) and e.g., alkyl ether sulphate such as sodium lauryl ether sulphate(SLES), soaps, fatty acid ester sulphonates, fatty acid sulphates or sulphonates; alkyl benzene sulphonates (LAS), sulphosuccinate esters, olefin sulphonates, paraffin sulphonates and organic phosphates; fatty alcohol sulphates; alkyl phenol ether sulphate; fatty acyl isethionate products which products comprise fatty acyl isethionate and free fatty acid and/or fatty acid salt; alkyl sulphonates such as sodium alkane sulphonate. Preferred anionic surfactants are the alkali (ammonium or triethylammonium for example) and alkaline earth metal salts of the above. The source oil/alcohol can be plant or animal derived for example coconut or palm or tallow etc.

LAS may be added as an acid and neutralised using Base Sodium Hydroxide solution during the formulation process.

Additionally or alternatively, the surfactant combination preferably comprises one or more non-ionic surfactants. Nonionic surfactants include primary and secondary alcohol ethoxylates, especially C8-C20 aliphatic alcohol ethoxylated with an average of from 1 to 20 moles of ethylene oxide per mole of alcohol, and more especially the C10-C15 primary and secondary aliphatic alcohols ethoxylated with an average of from 1 to 10 moles of ethylene oxide per mole of alcohol. Non-ethoxylated nonionic surfactants include alkyl polyglycosides, glycerol monoethers and polyhydroxy amides (glucamide). Mixtures of nonionic surfactant may be used. When included therein the composition contains from 0.1 to 20 wt % preferably 1 wt % to 15 wt %, more preferably 5 to 15 wt % of a non-ionic surfactant, for example alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Nonionic surfactants that may be used include the primary and secondary alcohol ethoxylates, especially the C8-C20 aliphatic alcohols ethoxylated with an average of from 1 to 35 moles of ethylene oxide per mole of alcohol, and more especially the C10-C15 primary and secondary aliphatic alcohols ethoxylated with an average of from 1 to 10 moles of ethylene oxide per mole of alcohol. The units of ethylene oxide may be an average.

Additionally or alternatively, the surfactant combination preferably comprises one or more amphoteric/zwitteronic surfactants. Preferred zwitterionic material is a carbobetaine available from Huntsman under the name Empigen® BB. Betaines and/or amine oxides, improve particulate soil detergency in the compositions.

The surfactant combination is present in the fabric or hard surface washing compositions at a level of from 3 to 85% by weight, preferably from 3 to 60% by weight, more preferably from 3 to 40% by weight, most preferably from 3 to 35% by weight.

The surfactant combination is present in personal (human skin and hair) wash compositions at a level of 5 to 60%, preferably 10 to 40% surfactant, while cosmetic compositions preferably comprise 1% to 30% by wt.

Preferably the ethoxylated polyethylene imine polymer (EPEI) is nonionic. By nonionic it is meant that it does not have any quaternary nitrogens, or nitrogen oxides or any ionic species other than possible pH affected protonation of nitrogens. Polyethylene imines (PEIs, especially modified PEIs) are materials composed of ethylene imine units —CH2CH2NH— and, where branched, the hydrogen on the nitrogen is replaced by another chain of ethylene imine units. These polyethyleneimines can be prepared, for example, by polymerizing ethyleneimine in the presence of a catalyst such as carbon dioxide, sodium bisulphite, sulphuric acid, hydrogen peroxide, hydrochloric acid, acetic acid, and the like. Specific methods for preparing these polyamine backbones are disclosed in U.S. Pat. No. 2,182,306, Ulrich et al., issued Dec. 5, 1939; U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep. 17, 1957; U.S. Pat. No. 2,553,696, Wilson, issued May 21, 1951 and WO2006/086492 (BASF).

Preferably, the EPEI comprises a polyethyleneimine backbone wherein the modification of the polyethyleneimine backbone is intended to leave the polymer without quaternisation. Such nonionic EPEI may be represented as PEI(X)YEO where X represents the molecular weight of the unmodified PEI and Y represents the average moles of ethoxylation per nitrogen atom in the polyethyleneimine backbone. The ethoxylation number Y may range from 9 to 40 ethoxy moieties per modification, preferably it is in the range of 16 to 26, most preferably 18 to 22. X is selected to be from about 300 to about 10000 weight average molecular weight and is preferably about 600.

The ethoxylated polyethyleneimine polymer (EPEI) is present in the composition preferably at a level of between 0.01 and 25 wt %, but more preferably at a level of at least 2 wt % and/or less than 9.5 wt %, most preferably from 3 to 9 wt % and with a ratio of non-soap surfactant to EPEI of from 2:1 to 7:1, preferably from 3:1 to 6:1, or even to 5:1.

The viscosity modifier may comprise a thickening or structuring polymer.

The thickening polymer may comprise linear/crosslinked alkali swellable acrylic copolymers/ASE/HASE/C-HASE.

The preferred thickening polymers are linear/crosslinked alkali swellable acrylic copolymers/ASE/HASE/C-HASE. Polymers that require alkaline conditions to swell and so to provide thickening of the detergent fluid should be added such that they are exposed to alkaline conditions at least during the manufacture of the fluid. It is not essential that the finished fluid is alkaline.

The thickening polymer is a water swellable polyacrylate. Such polymers may be alkali swellable copolymers (ASE) optionally with a hydrophobic modification on at least one of the monomers (HASE) or with crosslinking groups (CASE) and possibly with both hydrophobic modification and crosslinking (C-HASE).

As used herein the term “(meth)acrylic” refers to acrylic or methacrylic, and “(meth)acrylate” refers to acrylate or methacrylate. The term “acrylic polymers” refers to polymers of acrylic monomers, i.e., acrylic acid (AA), methacrylic acid (MAA) and their esters, and copolymers comprising at least 50% of acrylic monomers. Esters of AA and MAA include, but are not limited to, methyl methacrylate (MMA), ethyl methacrylate (EMA), butyl methacrylate (BMA), hydroxyethyl methacrylate (HEMA), methyl acrylate (MA), ethyl acrylate (EA), butyl acrylate (BA), and hydroxyethyl acrylate (HEA), as well as other alkyl esters of AA or MAA.

Preferably, acrylic polymers have at least 75% of monomer residues derived from (meth)acrylic acid or (meth)acrylate monomers, more preferably at least 90%, more preferably at least 95%, and most preferably at least 98%. The term “vinyl monomer” refers to a monomer suitable for addition polymerization and containing a single polymerizable carbon-carbon double bond.

Hydrophobic properties may be imparted by use of lipophilically-modified (meth)acrylate residues each of which may contain either one, or a plurality of, lipophilic groups. Such groups are suitably in the same copolymer component as and attached to hydrophilic chains, such as for example polyoxyethylene chains. Alternatively the copolymer may contain a vinyl group which may be used to copolymerize the polymer to other vinyl-containing entities to alter or improve the properties of the polymer. Polymerizable groups may be attached to lipophilic groups directly, or indirectly for example via one or more, for example up to 60, preferably up to 40, water-soluble linker groups, for example, —CH[R]CH2O— or —CH[R]CH2NH— groups wherein R is hydrogen or methyl. Alternatively, the polymerizable group may be attached to the lipophilic group by reaction of the hydrophilic, for example polyoxyethylene, component with a urethane compound containing unsaturation. The molecular weight of the lipophilic-modifying group or groups is preferably selected together with the number of such groups to give the required minimum lipophilic content in the copolymer, and preferably, for satisfactory performance in a wide range of liquids.

The amount of lipophilically-modified component in the copolymers preferably is at least 5%, more preferably at least 7.5%, and most preferably at least 10%; and preferably is no more than 25%, more preferably no more than 20%, more preferably no more than 18%, and most preferably no more than 15%.

The lipophilic-modifying groups themselves are preferably straight chain saturated alkyl groups, but may be aralkyl or alkyl carbocyclic groups such as alkylphenyl groups, having at least 6, and up to 30 carbon atoms although branched chain groups may be contemplated. It is understood that the alkyl groups may be either of synthetic or of natural origin and, in the latter case particularly, may contain a range of chain lengths.

The chain length of the lipophilic-modifying groups is preferably is below 25, more preferably from 8 to 22, and most preferably from 10 to 18 carbon atoms. The hydrophilic component of the lipophilically-modified copolymer may suitably be a polyoxyethylene component preferably comprising at least one chain of at least 2, preferably at least 5, more preferably at least 10, and up to 60, preferably up to 40, more preferably up to 30 ethylene oxide units. Such components are usually produced in a mixture of chain lengths.

Preferably, the C2-C4 alkyl (meth)acrylate residues in the copolymer are C2-C3 alkyl (meth)acrylate residues, and most preferably EA. Preferably, the amount of C2-C4 alkyl (meth)acrylate residues is at least 20%, more preferably at least 30%, more preferably at least 40% and most preferably at least 50%. Preferably, the amount of C2-C4 alkyl (meth)acrylate residues is no more than 75%, more preferably no more than 70%, and most preferably no more than 65%. Preferably, the amount of acrylic acid residues in the copolymer used in the present invention is at least 5%, more preferably at least 7.5%, more preferably at least 10%, and most preferably at least 15%. Preferably, the amount of acrylic acid residues is no more than 27.5%, more preferably no more than 25%, and most preferably no more than 22%. Acrylic acid residues are introduced into the copolymer by inclusion of either acrylic acid, or an acrylic acid oligomer having a polymerizable vinyl group, in the monomer mixture used to produce the copolymer. Preferably, the copolymer contains residues derived from methacrylic acid in an amount that provides a total acrylic acid plus methacrylic acid content of at least 15%, more preferably at least 17.5%, and most preferably at least 20%. Preferably, the total acrylic acid plus methacrylic acid content of the copolymer is no more than 65%, more preferably no more than 50%, and most preferably no more than 40%.

Optionally, the copolymer also contains from 2% to 25%, preferably from 5% to 20%, of a hydrophilic comonomer, preferably one having hydroxyl, carboxylic acid or sulphonic acid functionality. Examples of hydrophilic comonomers include 2-hydroxyethyl (meth)acrylate (HEMA or HEA), itaconic acid and acrylamido-2-methylpropanesulfonic acid.

The fluids of the present invention contain from 0.1% and preferably no more than 10% of thickening polymer; i.e., the total amount of copolymer(s) is in this range. Preferably, the amount of copolymer in the fluid is at least 0.3%, more preferably at least 0.5%, more preferably at least 0.7%, and most preferably at least 1%. Preferably, the amount of copolymer in the aqueous fluid is no more than 7%, more preferably no more than 5%, and most preferably no more than 3%. Preferably, the copolymer is an acrylic polymer. The copolymer, in aqueous dispersion or in the dry form, may be blended into an aqueous system to be thickened followed, in the case of a pH-responsive thickener, by a suitable addition of acidic or basic material if required. In the case of copolymeric pH-responsive thickeners, the pH of the system to be thickened is at, or is adjusted to, at least 5, preferably at least 6, more preferably at least 7; preferably the pH is adjusted to no more than 13. The neutralizing agent is preferably a base such as an amine base or an alkali metal or ammonium hydroxide, most preferably sodium hydroxide, ammonium hydroxide or triethanolamine (TEA). Alternatively, the copolymer may first be neutralized in aqueous dispersion and then blended. The surfactant preferably is blended into the aqueous fluid separately from the copolymer prior to neutralization.

The molecular weight of uncrosslinked polymer is typically in the range of about 100,000 to 1 million.

In the case that the polymer is crosslinked, a crosslinking agent, such as a monomer having two or more ethylenic unsaturated groups, is included with the copolymer components during polymerization. Examples of such monomers include diallyl phthalate, divinylbenzene, allyl methacrylate, diacrylobutylene or ethylene glycol dimethacrylate. When used, the amount of crosslinking agent is typically from 0.01% to 2%, preferably from 0.1 to 1% and more preferably from 0.2 to 0.8%, based on weight of the copolymer components.

The copolymer may be prepared in the presence of a chain transfer agent when a crosslinking agent is used. Examples of suitable chain transfer agents are carbon tetrachloride, bromoform, bromotrichloromethane, and compounds having a mercapto group, e.g., long chain alkyl mercaptans and thioesters such as dodecyl-, octyl-, tetradecyl- or hexadecyl-mercaptans or butyl-, isooctyl- or dodecyl-thioglycolates. When used, the amount of chain transfer agent is typically from 0.01% to 5%, preferably from 0.1% to 1%, based on weight of the copolymer components. If the crosslinking agent is used in conjunction with a chain transfer agent, which are conflicting operations for polymerization purposes, not only is exceptional efficiency observed but also very high compatibility with hydrophilic surfactants, as manifested by increased product clarity.

Hydrophobically modified polyacrylate thickening polymers are available as Acusol polymers from Dow.

An alternative or additional polymer type that may be utilised is described in WO2011/117427 (Lamberti). These polymers comprise:

i) from 0.2 to 10% by weight of a thickening agent which is a crosslinked alkali swellable polyacrylate obtainable by polymerization of:

a) from 20 to 70% by weight of a monoethylenically unsaturated monomer containing a carboxylic group;

b) from 20 to 70% by weight of a (meth)acrylic acid ester;

c) from 0.05 to 3% by weight of an unsaturated monomer containing one or more acetoacetyl or cyanoacetyl groups;

d) from 0.01 to 3% by weight of a polyethylenically unsaturated monomer; e) from 0 to 10% by weight of a nonionic acrylic associative monomer; ii) from 5 to 60% by weight of a detergent component consisting of at least one compound selected from anionic surfactants, amphoteric surfactants, cationic surfactants, zwitterionic surfactants, non-ionic surfactants and mixture thereof.

Such crosslinked alkali swellable polyacrylates containing one or more acetoacetyl or cyanoacetyl groups possess high thickening capability in the presence of surfactants and electrolytes, provide homogeneous and clear solutions and possess improved suspending and thickening properties in comparison with crosslinked alkali swellable polyacrylates of the prior art. Crosslinked thickening polymers of this type are available as Viscolam thickening polymers from Lamberti.

Other commercially available polymers are Lubrizol and/or Carbopol polymers ex Lubrizol Co. Other thickeners include citrus fibre pulps, polysaccharide based thickeners, gums e.g., guar gum, xanthan gum or any combination thereof etc.

The Volatile Benefit Agent

Suitable volatile benefit agents include but are not limited to perfumes, insect repellents, essential oils, sensates such as menthol and aromatherapy actives, preferably perfumes. Mixtures of volatile benefit agents may be used.

The total amount of volatile benefit agent is preferably from 0.01 to 10% by weight, more preferably from 0.05 to 5% by weight, even more preferably from 0.1 to 4.0%, most preferably from 0.15 to 4.0% by weight, based on the total weight of the fluid.

The preferred volatile benefit agent is a perfume.

Thus the consumer experience is greatly enhanced by a greater perfume sensation and this then ‘primes’ the consumer for enhanced enjoyment of the particular perfume during later activities e.g., during personal washing or hand washing of fabrics or after washing and drying when handling fabrics.

The perfumes of the invention comprise an unconfined (also called non-encapsulated) volatile benefit agent.

Any suitable perfume or mixture of perfumes may be used.

Useful components of the perfume include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products, i.e., of imparting an odour and/or a flavour or taste to a consumer product traditionally perfumed or flavoured, or of modifying the odour and/or taste of said consumer product.

By perfume in this context is not only meant a fully formulated product fragrance, but also selected components of that fragrance, particularly those which are prone to loss, such as the so-called ‘top notes’.

Top notes are defined by Poucher (Journal of the Society of Cosmetic Chemists 6(2):80 [1955]). Examples of well-known top-notes include citrus oils, linalool, linalyl acetate, lavender, dihydromyrcenol, rose oxide and cis-3-hexanol. Top notes typically comprise 15-25% wt of a perfume liquid and in those embodiments of the invention which contain an increased level of top-notes it is envisaged at that least 20% wt would be present within the encapsulate.

Some or all of the perfume or pro-fragrance may be encapsulated, typical perfume components which it is advantageous to encapsulate, include those with a relatively low boiling point, preferably those with a boiling point of less than 300, preferably 100-250 Celsius and pro-fragrances which can produce such components.

It is also advantageous to encapsulate perfume components which have a low Clog P (i.e., those which will be partitioned into water), preferably with a Clog P of less than 3.0. These materials, of relatively low boiling point and relatively low Clog P have been called the “delayed blooming” perfume ingredients and include the following materials:

Allyl Caproate, Amyl Acetate, Amyl Propionate, Anisic Aldehyde, Anisole, Benzaldehyde, Benzyl Acetate, Benzyl Acetone, Benzyl Alcohol, Benzyl Formate, Benzyl Iso Valerate, Benzyl Propionate, Beta Gamma Hexenol, Camphor Gum, Laevo-Carvone, d-Carvone, Cinnamic Alcohol, Cinamyl Formate, Cis-Jasmone, cis-3-Hexenyl Acetate, Cuminic Alcohol, Cyclal C, Dimethyl Benzyl Carbinol, Dimethyl Benzyl Carbinol Acetate, Ethyl Acetate, Ethyl Aceto Acetate, Ethyl Amyl Ketone, Ethyl Benzoate, Ethyl Butyrate, Ethyl Hexyl Ketone, Ethyl Phenyl Acetate, Eucalyptol, Eugenol, Fenchyl Acetate, Flor Acetate (tricyclo Decenyl Acetate), Frutene (tricycico Decenyl Propionate), Geraniol, Hexenol, Hexenyl Acetate, Hexyl Acetate, Hexyl Formate, Hydratropic Alcohol, Hydroxycitronellal, Indone, Isoamyl Alcohol, Iso Menthone, Isopulegyl Acetate, Isoquinolone, Ligustral, Linalool, Linalool Oxide, Linalyl Formate, Menthone, Menthyl Acetophenone, Methyl Amyl Ketone, Methyl Anthranilate, Methyl Benzoate, Methyl Benyl Acetate, Methyl Eugenol, Methyl Heptenone, Methyl Heptine Carbonate, Methyl Heptyl Ketone, Methyl Hexyl Ketone, Methyl Phenyl Carbinyl Acetate, Methyl Salicylate, Methyl-N-Methyl Anthranilate, Nerol, Octalactone, Octyl Alcohol, p-Cresol, p-Cresol Methyl Ether, p-Methoxy Acetophenone, p-Methyl Acetophenone, Phenoxy Ethanol, Phenyl Acetaldehyde, Phenyl Ethyl Acetate, Phenyl Ethyl Alcohol, Phenyl Ethyl Dimethyl Carbinol, Prenyl Acetate, Propyl Bornate, Pulegone, Rose Oxide, Safrole, 4-Terpinenol, Alpha-Terpinenol, and/or Viridine

Preferred non-encapsulated perfume ingredients are those hydrophobic perfume components with a ClogP above 3. As used herein, the term “ClogP” means the calculated logarithm to base 10 of the octanol/water partition coefficient (P). The octanol/water partition coefficient of a perfume raw material (PRM) is the ratio between its equilibrium concentrations in octanol and water. Given that this measure is a ratio of the equilibrium concentration of a PRM in a non-polar solvent (octanol) with its concentration in a polar solvent (water), ClogP is also a measure of the hydrophobicity of a material—the higher the ClogP value, the more hydrophobic the material. ClogP values can be readily calculated from a program called “CLOGP” which is available from Daylight Chemical Information Systems Inc., Irvine Calif., USA. Octanol/water partition coefficients are described in more detail in U.S. Pat. No. 5,578,563.

Perfume components with a ClogP above 3 comprise: Iso E super, citronellol, Ethyl cinnamate, Bangalol, 2,4,6-Trimethylbenzaldehyde, Hexyl cinnamic aldehyde, 2,6-Dimethyl-2-heptanol, Diisobutylcarbinol, Ethyl salicylate, Phenethyl isobutyrate, Ethyl hexyl ketone, Propyl amyl ketone, Dibutyl ketone, Heptyl methyl ketone, 4,5-Dihydrotoluene, Caprylic aldehyde, Citral, Geranial, Isopropyl benzoate, Cyclohexanepropionic acid, Campholene aldehyde, Caprylic acid, Caprylic alcohol, Cuminaldehyde, 1-Ethyl-4-nitrobenzene, Heptyl formate, 4-lsopropylphenol, 2-lsopropylphenol, 3-lsopropylphenol, Allyl disulfide, 4-Methyl-1-phenyl-2-pentanone, 2-Propylfuran, Allyl caproate, Styrene, lsoeugenyl methyl ether, lndonaphthene, Diethyl suberate, L-Menthone, Menthone racemic, p-Cresyl isobutyrate, Butyl butyrate, Ethyl hexanoate, Propyl valerate, n-Pentyl propanoate, Hexyl acetate, Methyl heptanoate, trans-3,3,5-Trimethylcyclohexanol, 3,3,5-Trimethylcyclohexanol, Ethyl p-anisate, 2-Ethyl-1-hexanol, Benzyl isobutyrate, 2,5-Dimethylthiophene, Isobutyl 2-butenoate, Caprylnitrile, gamma-Nonalactone, Nerol, trans-Geraniol, 1-Vinylheptanol, Eucalyptol, 4-Terpinenol, Dihydrocarveol, Ethyl 2-methoxybenzoate, Ethyl cyclohexanecarboxylate, 2-Ethylhexanal, Ethyl amyl carbinol, 2-Octanol, 2-Octanol, Ethyl methylphenylglycidate, Diisobutyl ketone, Coumarone, Propyl isovalerate, Isobutyl butanoate, Isopentyl propanoate, 2-Ethylbutyl acetate, 6-Methyl-tetrahydroquinoline, Eugenyl methyl ether, Ethyl dihydrocinnamate, 3,5-Dimethoxytoluene, Toluene, Ethyl benzoate, n-Butyrophenone, alpha-Terpineol, Methyl 2-methylbenzoate, Methyl 4-methylbenzoate, Methyl 3, methylbenzoate, sec. Butyl n-butyrate, 1,4-Cineole, Fenchyl alcohol, Pinanol, cis-2-Pinanol, 2,4, Dimethylacetophenone, Isoeugenol, Safrole, Methyl 2-octynoate, o-Methylanisole, p-Cresyl methyl ether, Ethyl anthranilate, Linalool, Phenyl butyrate, Ethylene glycol dibutyrate, Diethyl phthalate, Phenyl mercaptan, Cumic alcohol, m-Toluquinoline, 6-Methylquinoline, Lepidine, 2-Ethylbenzaldehyde, 4-Ethylbenzaldehyde, o-Ethylphenol, p-Ethylphenol, m-Ethylphenol, (+)-Pulegone, 2,4-Dimethylbenzaldehyde, Isoxylaldehyde, Ethyl sorbate, Benzyl propionate, 1,3-Dimethylbutyl acetate, Isobutyl isobutanoate, 2,6-Xylenol, 2,4-Xylenol, 2,5-Xylenol, 3,5-Xylenol, Methyl cinnamate, Hexyl methyl ether, Benzyl ethyl ether, Methyl salicylate, Butyl propyl ketone, Ethyl amyl ketone, Hexyl methyl ketone, 2,3-Xylenol, 3,4, Xylenol, Cyclopentadenanolide and Phenyl ethyl 2 phenylacetate 2.

In the fluids of the present invention it is envisaged that there will be four or more, preferably five or more, more preferably six or more or even seven or more different perfume components from the list given of delayed blooming perfumes given above and/or the list of perfume components with a ClogP above 3 present in the perfume.

Insect repellent

In chemical terms, most repellent actives belong to one of four groups: amides, alcohols, esters or ethers. Those suitable for use in the present invention are liquids or solids with a relatively low melting point and a boiling point above 150° C., preferably liquids. They evaporate slowly at room temperature. Where the volatile benefit agent is an insect repellent, the repellents described below are suitable for use as the encapsulated volatile benefit agent and also as the unconfined repellent component.

Many suitable insect repellents are related to perfume species (many fall into both classes). The most commonly used insect repellents include: DEET (N,N-diethyl-m-toluamide), essential oil of the lemon eucalyptus (Corymbia citriodora) and its active compound p-menthane-3,8-diol (PMD), Icaridin, also known as Picaridin, D-Limonene, Bayrepel, and KBR 3023, Nepetalactone, also known as “catnip oil”, Citronella oil, Permethrin, Neem oil and Bog Myrtle.

Preferred insect repellents are related to perfume species.

Known insect repellents derived from natural sources include: Achillea alpina, alpha-terpinene, Basil oil (Ocimum basilicum), Callicarpa americana (Beautyberry), Camphor, Carvacrol, Castor oil (Ricinus communis), Catnip oil (Nepeta species), Cedar oil (Cedrus atlantica), Celery extract (Apium graveolens), Cinnamon (Cinnamomum Zeylanicum, leaf oil), Citronella oil (Cymbopogon fleusus), Clove oil (Eugenic caryophyllata), Eucalyptus oil (70%+eucalyptol, also known as cineol), Fennel oil (Foeniculum vulgare), Garlic Oil (Allium sativum), Geranium oil (also known as Pelargonium graveolens), Lavender oil (Lavandula officinalis), Lemon eucalyptus (Corymbia citriodora) essential oil and its active ingredient p-menthane-3,8-diol (PMD), Lemongrass oil (Cymbopogon flexuosus), Marigolds (Tagetes species), Marjoram (Tetranychus urticae and Eutetranychus orientalis), Neem oil (Azadirachta indica), Oleic acid, Peppermint (Mentha x piperita), Pennyroyal (Mentha pulegium), Pyrethrum (from Chrysanthemum species, particularly C. cinerariifolium and C. coccineum), Rosemary oil (Rosmarinus officinalis), Spanish Flag Lantana camara (Helopeltis theivora), Solanum villosum berry juice, Tea tree oil (Melaleuca alternifolia) and Thyme (Thymus species) and mixtures thereof.

Preferred Volatile Benefit Agents are Aromatherapy Materials and/or Essential Oils

These include components of essential oils such as Clary Sage, Eucalyptus, Geranium, Lavender, Mace Extract, Neroli, Nutmeg, Spearmint, Sweet Violet Leaf and Valerian

Compositions of the invention may further comprise encapsulated volatile benefit agents. Preferred encapsulated insect repellents are mosquito repellents available from Celessence, Rochester, England. Celessence Repel, containing the active ingredient Saltidin™ and Celessence Repel Natural, containing the active Citrepel™ 75. Saltidin is a man-made molecule developed originally by the Bayer Corporation. Citrepel is produced from eucalyptus oils and is high in p-menthane-3,8-diol (PMD). A preferred non-encapsulated repellent is Citriodiol™ supplied by Citrefine.

Compositions of the invention may further comprise moisturizers and/or emollients for skin and/or hair including without limitation, vegetable oils, esters, animal fats, fatty acids and alcohols, mineral oil, petrolatum, silicone oil such as dimethyl polysiloxane, lauryl and myristyl lactate.

Hair cleaning compositions may further include anti-dandruff actives, silicones, cationic polymers.

Hand washing and fabric cleaning compositions may further comprise any of the following components polyester substantive soil release polymers, hydrotropes, opacifiers, colorants, enzymes, further surfactants such as cationic, softeners, polymers for anti re-deposition of soil, further bleach, bleach activators and bleach catalysts; antioxidants, pH control agents and buffers, external structurants for rheology modification known to those skilled in the art.

Cleaning compositions of the invention are preferably aqueous, i.e., they have water or an aqueous solution or a lyotropic liquid crystalline phase as their major component. Suitably, the composition will comprise from 50 to 98%, preferably from 60 to 90% water by weight based on the total weight of the composition.

Preferably the composition comprises an ionic salt. The salt preferably comprises any organic or inorganic cation, including without limitation cations of alkali metals Cs, Na, K, Ca, Mg etc., with anions including halide anions, more preferably Cl. Other preferred salts comprise organic cations e.g., amides (—⁺NH—R) or ammonium cations or substituted forms thereof e.g., triethylammonium. Anions for organic cations may comprise any akyl, aryl, arylalkyl moiety which may be short, medium, long, branched, cyclic or linear.

Preferably the composition comprises from 0.01-5% by weight of the salt. In the case of NaCl, preferably the level is in the range 0.5-2 wt. %. The salt may also include MgSO₄.

The composition is especially useful for washing in water with a high water hardness, preferably of greater than 5° FH preferably greater than 40° FH, more preferably greater than 90° FH.

The composition is preferably a liquid or gel.

The invention will be further described with reference to the following non-limiting examples as follows:

Mono and Di rhamnolipids were extracted and purified from a commercial sample of JBR425, supplied by Jeneil, using Supercritical CO₂ using the following method.

A commercial sample of JBR425 (ex Jeneil) was mixed with a Celite 454® support and transferred to a supercritical CO2 extractor. The temperature and pressure was increased to produce supercritical CO2 and residual oils and fats were removed from the extractor in a defatting step. A cosolvent, industrial methylated solvent (IMS) was then added to the remaining defatted rhamnolipid mixture on the Cellte 454® support in the presence of supercritical CO2. The co-solvent IMS was introduced at an increasing gradient from 2.5% to 10% to facilitate the separation and removal of the different mono and di rhamnolipid ratios.

Method for Making the Cleaning Composition

Laundry and hand dish washing formulations were produced by mixing ingredients via a Heidolf Mixer.

For Laundry Initially a large scale batch between 100 and 1 L was produced with composition as defined in the formulation sheets.

The formulations were made and the order of addition as indicated in the formulations below.

Method for Measuring Viscosity of the Samples

Formulations were produced according to the Protocol. The rheological properties were then assessed using an Anton Paar ASC Rheometer at 25° C.

The rheology measurement was performed with the serrated cup and bob geometry. The bob used was the CC27/P2 SN9625 with the serrated cup related to this geometry. Each cup contained between 24 g to 26 g of samples. All the cups were maintained at 25° C. by a Jumbalo F32 thermo bath.

The rheological measurement contains three different steps:
Step 1 shear stress control measurements from 0.01 Pa to 400 Pa.
Step 2 shear rate control measurements from 0.1 s⁻1 to 1200 s⁻1.
Step 3 shear rate control measurements from 1200s⁻1 to 0.1 s⁻1.

After the experimental measurement was carried out we collected the data from the Rheoplus software for analysis. The data presented shows the viscosity of the formulation at a shear rate of 23 s⁻¹ as this corresponds to the pouring viscosity of the formulation

Laundry Formulations containing No EPEI with thickening polymer and perfume—No Rhamnolipid,

| | | 1 | 2 |
|---|---|---|---|
| | | as | as |
| | | 100% | 100% |
| OOA | Name | (%) | (%) |
| 1 | Demin water | 43.275 | 44.665 |
| 2 | Tinopal CBS-SP- Ciba | 0.250 | 0.250 |
| 3 | MPG - Dow | 8.000 | 8.000 |
| 4 | Neodol 25_7 - Shell | 8.400 | 8.400 |
| 5 | Viscolam CK57 - ex-Lamberti | 1.000 | 1.000 |
| 5 | Acusol 820 - Dow | 0.000 | 0.000 |
| 5 | Acusol WR - Dow | 0.000 | 0.000 |
| 5 | Lubrizol SF1 - Lubrizol | 0.000 | 0.000 |
| 6 | MEA - Dow | 6.200 | 6.200 |
| 7 | EU LAS acid - Petresa HF | 11.200 | 11.200 |
| | plus PSU Sulphonation | | |
| 8 | Rhamnolipid (Di rhamnolipid) - | 0.000 | 0.000 |
| | Purified from Jeneil | | |
| 9 | TEA - Dow | 4.035 | 4.035 |
| 10 | Citric Acid - Tate and Lyle | 2.500 | 2.500 |
| 11 | Fatty acid Palmera B1231 - | 3.500 | 3.500 |
| 12 | Dequest 2010 - ex | 1.500 | 1.500 |
| | Thermophos | | |
| 13 | Sodium Sulphite - | 0.250 | 0.250 |
| 14 | EU SLES 3EO - ex PS | 8.400 | 8.400 |
| | Sulphonation (synthetic | | |
| | source) | | |
| 15 | EPEI -BASF | 0.000 | 0.000 |
| 16 | perfume | 1.390 | 0.000 |
| 17 | Acusol OP301 - Dow | 0.100 | 0.100 |
| | | 100.000 | 100.000 |

Formulations with EPEI and thickening polymers in the presence and absence of perfume—No Rhamnolipid

| | | 3 | 4 | 5 | 6 |
|---|---|---|---|---|---|
| | | as | as | as | as |
| | | 100% | 100% | 100% | 100% |
| OOA | Name | (%) | (%) | (%) | (%) |
| 1 | Demin water | 39.608 | 40.998 | 39.473 | 40.863 |
| 2 | Tinopal CBS-SP- Ciba | 0.250 | 0.250 | 0.250 | 0.250 |
| 3 | MPG - DOW | 8.000 | 8.000 | 8.000 | 8.000 |
| 4 | Neodol 25_7 - Shell | 8.400 | 8.400 | 8.400 | 8.400 |
| 5 | Viscolam CK57 - | 1.000 | 1.000 | 0.000 | 0.000 |
| | ex-Lamberti | | | | |
| 5 | Acusol 820 - Dow | 0.000 | 0.000 | 1.000 | 1.000 |
| 5 | Acusol WR - Dow | 0.000 | 0.000 | 0.000 | 0.000 |
| 5 | Lubrizol SF1 - Lubrizol | 0.000 | 0.000 | 0.000 | 0.000 |
| 6 | MEA - Dow | 6.200 | 6.200 | 6.200 | 6.200 |
| 7 | EU LAS acid - Petresa HF | 11.200 | 11.200 | 11.200 | 11.200 |
| | plus PSU Sulphonation | | | | |
| 8 | Rhamnolipid (Di | 0.000 | 0.000 | 0.000 | 0.000 |
| | rhamnolipid) - | | | | |
| | Purified from Jeneil | | | | |
| 9 | TEA - Dow | 4.000 | 4.000 | 4.000 | 4.000 |
| 10 | Citric Acid - Tate and Lyle | 2.202 | 2.202 | 2.337 | 2.337 |
| 11 | Faty acid Palmera B1231 - | 3.500 | 3.500 | 3.500 | 3.500 |
| 12 | Dequest 2010 - ex | 1.500 | 1.500 | 1.500 | 1.500 |
| | Thermophos | | | | |
| 13 | Sodium Sulphite - | 0.250 | 0.250 | 0.250 | 0.250 |
| 14 | EU SLES 3EO - ex PS | 8.400 | 8.400 | 8.400 | 8.400 |
| | Sulphonation (synthetic | | | | |
| | source) | | | | |
| 15 | EPEI -BASF | 4.000 | 4.000 | 4.000 | 4.000 |
| 16 | Perfume | 1.390 | 0.000 | 1.390 | 0.000 |
| 17 | Acusol OP301 - Dow ∘ | 0.100 | 0.100 | 0.100 | 0.100 |
| | | 100.000 | 100.000 | 100.000 | 100.000 |

Formulations with EPEI and thickening Polymers in the presence and absence of perfume—With Rhamnolipid

| | | 7 | 8 | 9 | 10 |
|---|---|---|---|---|---|
| | | as 100% | as 100% | as 100% | as 100% |
| OOA | Name | (%) | (%) | (%) | (%) |
| 1 | Demin water | 39.540 | 40.930 | 41.080 | 42.470 |
| 2 | Tinopal CBS-SP- Ciba | 0.250 | 0.250 | 0.250 | 0.250 |
| 3 | MPG - DOW | 8.000 | 8.000 | 8.000 | 8.000 |
| 4 | Neodol 25_7 - Shell | 5.040 | 5.040 | 5.040 | 5.040 |
| 5 | Viscolam CK57 - ex-Lamberti | 1.000 | 1.000 | 0.000 | 0.000 |
| 5 | Acusol 820 - Dow | 0.000 | 0.000 | 1.000 | 1.000 |
| 5 | Acusol WR - Dow | 0.000 | 0.000 | 0.000 | 0.000 |
| 5 | Lubrizol SF1 - Lubrizol | 0.000 | 0.000 | 0.000 | 0.000 |
| 6 | MEA - Dow | 6.640 | 6.640 | 6.250 | 6.250 |
| 7 | EU LAS acid - Petresa HF plus | 6.720 | 6.720 | 6.720 | 6.720 |
| | PSU Sulphonation | | | | |
| 8 | Rhamnolipid (Di rhamnolipid) - | 12.600 | 12.600 | 12.600 | 12.600 |
| | Purified from Jeneil | | | | |
| 9 | TEA - Dow | 4.000 | 4.000 | 3.080 | 3.080 |
| 10 | Citric Acid - Tate and Lyle | 1.830 | 1.830 | 1.600 | 1.600 |
| 11 | Fatty acid Palmera B1231 - | 2.100 | 2.100 | 2.100 | 2.100 |
| 12 | Dequest 2010 - ex Thermophos | 1.500 | 1.500 | 1.500 | 1.500 |
| 13 | Sodium Sulphite - | 0.250 | 0.250 | 0.250 | 0.250 |
| 14 | EU SLES 3EO - ex PS | 5.040 | 5.040 | 5.040 | 5.040 |
| | Sulphonation (synthetic source) | | | | |
| 15 | EPEI -BASF | 4.000 | 4.000 | 4.000 | 4.000 |
| 16 | Perfume | 1.390 | 0.000 | 1.390 | 0.000 |
| 17 | Acusol OP301 - Dow ∘ | 0.100 | 0.100 | 0.10000 | 0.10000 |
| | | 100.000 | 100.000 | 100.000 | 100.000 |

Notes:
OOA is order of addition.
Tinopal CBS SP Slurry 33 a Distyryl biphenyl derivative CAS No. 27344-41-8 Acusol 820, a copolymer of acrylic acid with C18 and with EO20C18 side chains, MW about 500,000
Prifac 5908 is Hydrogenated Topped Palm Kernel Fatty Acids = Dequest 2010 is 1-Hydroxyl ethylidene-1,1,-diphosphonic acid, HEDP Sokolan HP20 is ethoxylated polyethylene imine
Neodol 25-7 is is a primary C12-C15 Alcohol Ethoxylate with average of 7 moles of ethylene oxide per mole of alcohol
Acusol 820 is Hydrophobically modified Alkali soluble acrylic polymer emulsion
EU LAS is Linear Alkyl Benzene Sulphonate
SLES 3EO is Sodium Lauryl Ether Sulphate with average distribution of 3 moles of ethylene oxide per mole of Sodium Lauryl Sulphate
Accusol OP301 is an opacifier in an emulsion

Rhamnolipid JBR 425 is a mixture of mono and Di rhamnolipids where the IUPAC name for mono rhamnolipid is 3-[3-[(2R,3R,4R,5R,6S)-3,4,5-trihydroxy-6-methyloxan-2-yl]oxydecanoyloxy]decanoic acid and Di rhamnolipid is 3-[3-[4,5-dihydroxy-6-methyl-3-(3,4,5-trihydroxy-6-methyloxan-2-yl)oxyoxan-2-yl]oxydecanoyloxy]decanoic acid

Mono and Di rhamnolipids were extracted and purified from a commercial sample of JBR425, supplied by Jeneil, using Supercritcal CO2 using the following method.

A commercial sample of JBR425 was mixed with a celllite 454 support and transferred to a Supercritical CO2 extractor. The Temperature and pressure was increased to produce Supercritical CO2 and residual oils and fats were removed from the extractor (defatting) A cosolvent (Industrial Methylated Solvent) was then added to the remaining defatted rhamnolipid on the cellite 454 support in the presence of Supercritical CO2. The IMS is introduced at an increasing gradient from 2.5% to 10% to facilitate the separation and removal of the different mono and di rhamnolipid components.

Results

Pouring Viscosities and formulation stability of formulations

| | % | | | Thick- | | % | Viscos- |
|---|---|---|---|---|---|---|---|
| | Rhamolipid | % | Per- | ening | % | Acusol | ity at |
| ID | (R2) | EPEI | fume | polymer | Viscolam | 820 | 23s−1 |
| 1 | 0 | 0 | Yes | Yes | 1 | 0 | 296 |
| 2 | 0 | 0 | No | Yes | 1 | 0 | 388 |
| 3 | 0 | 4 | Yes | Yes | 1 | 0 | FAIL |
| 4 | 0 | 4 | No | Yes | 1 | 0 | 301 |
| 5 | 0 | 4 | Yes | Yes | 0 | 1 | FAIL |
| 6 | 0 | 4 | No | Yes | 0 | 1 | 356 |
| 7 | 40 | 4 | Yes | Yes | 1 | 0 | 354 |
| 8 | 40 | 4 | No | Yes | 1 | 0 | 362 |
| 9 | 40 | 4 | Yes | Yes | 0 | 1 | 403 |
| 10 | 40 | 4 | No | Yes | 0 | 1 | 426 |

Conclusions

The results show that to produce a formulation at desirably higher pouring viscosity in the presence of EPEI and perfume using thickening polymers to achieve the pouring viscosity then the inclusion of a glycolipid such as rhamnolipids is required to produce a stable formulation.

1. A viscous perfumed cleaning fluid for a cleaning a substrate comprising:
(a) a surfactant combination comprising:
(i) at least one surfactant; and
(ii) a glycolipid biosurfactant which is present at a level in the range 10-95 wt % of the total surfactant in said surfactant system, and
(b) one or more viscosity modifiers; and
(c) ethoxylated polyethylene imine (EPEI); and
(d) a volatile benefit agent;
wherein the composition has a pour viscosity as measured at 21 of between 250 CPs to 3000 Cps.

2. A viscous perfumed cleaning fluid according to claim 1 wherein the glycolipid comprises a rhamnolipid.

3. A viscous perfumed cleaning fluid according to claim 2 wherein the rhamnolipid comprises a mixture with R1:R2 ratio in the range: 10:90 wt %-90:10 wt %0%,

4. A viscous perfumed cleaning fluid according to claim 1, wherein the glycolipid is present at 5%-95% of the total surfactant combination.

5. A viscous perfumed cleaning fluid according to claim 1, wherein the ethoxylated polyethylene imine (EPEI) is non-ionic.

6. A viscous perfume cleaning fluid according to claim 1, wherein the surfactant combination preferably comprises a synthetic anionic surfactant.

7. A viscous perfume cleaning fluid according to claim 1 wherein at least part of the volatile benefit agent comprises a perfume.

8. A viscous perfume cleaning fluid according to claim 1 wherein at least part of the perfume is a free oil or non-encapsulate,

9. A method for making a viscous fluid cleaning composition for cleaning a substrate with a high pouring viscosity, the composition comprising the steps of:
(a) admixing a surfactant combination by mixing:
(i) at least one surfactant; and
(ii) a glycolipid biosurfactant which is present at a level in the range 10-95 wt % of the total surfactant in said surfactant system,
(b) one or more viscosity modifiers; and
(c) ethoxylated polyethylene imine EPEI; and
(d) a volatile benefit agent.

10. A method according to claim 9 wherein addition of the glycolipid surfactant and the or each viscosity modifier is prior to the addition of any volatile benefit agent.

11. A method according to claim 10 wherein the fluid is according to claim 1.
